(19) United States
(12) Patent Application Publication
(10) Pub. No.: US 2006/0091632 A1
(43) Pub. Date: May 4, 2006

(54) RB transporter

(76) Inventor: Robert T. Buck, Johnstown, PA (US)

Correspondence Address: Robert Buck, 736 Demuth Street, Johnstown, PA, 15904, US

(21) Appl. No.: 10/899,464

(22) Filed: Oct. 7, 2004

(51) Int. Cl. B62B 15/00; B62B 5/00

(52) U.S. Cl. 280/79.11; 280/14.24

(57) ABSTRACT

The RB Transporter was developed to make the movement of the rescue basket easier and safer. Placing wheels under the rescue basket accomplished it. The reason that the RB Tansporter improves the other wheeled unit for stokes basket. Is simple the RB transporter has four (4) wheels not just one. Does not need four persons to stabilize the basket from rocking or tippng over. The RB Transporter has a lower center of gravity. The RB Transporter can be stored in 12×12×48 inch area.

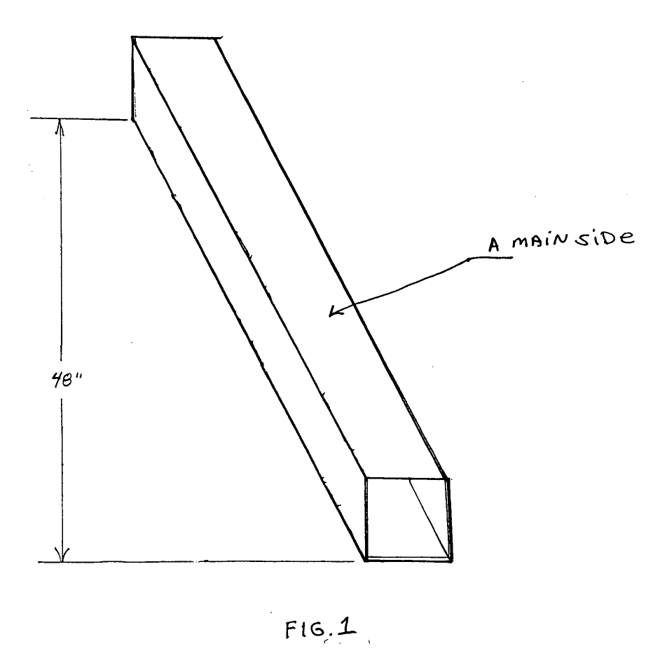

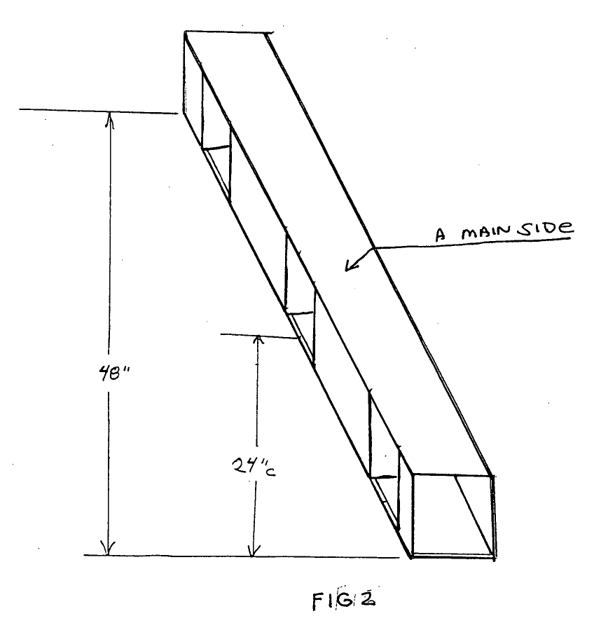

The RS Transporter has 2- (A) Main Sides, which are 48 inches long and 2 inches square by ⅛ inch thick, made of Fiber Reinforced Polymer Composites and/or metal. FIG. 1

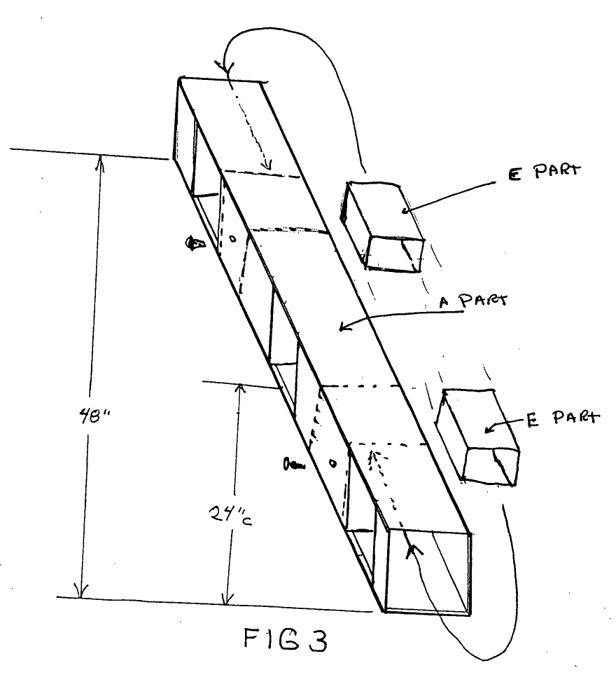

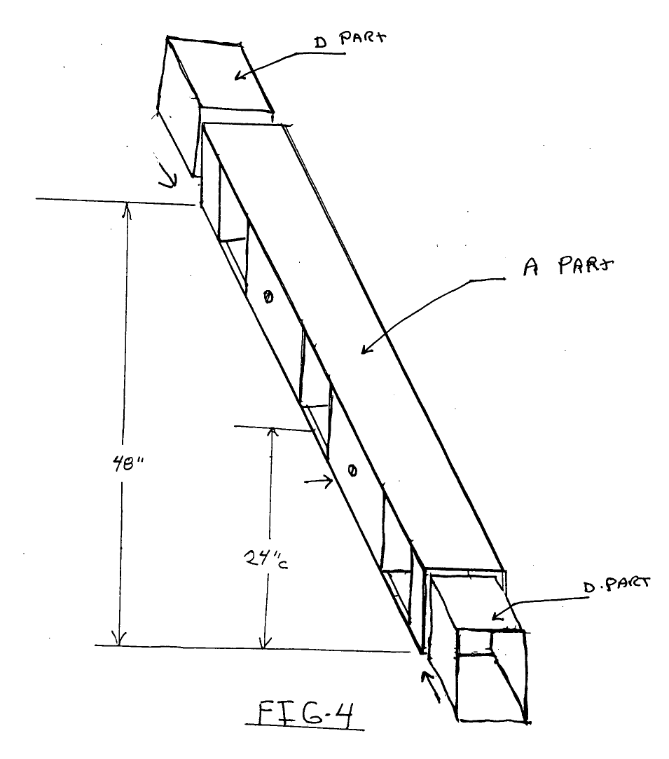

The (A) main sides will be cutout with a 1¾×1¾ inch square cutout on the inside of them for the (B) Part. The cutouts will be located as follows the 2 inches from each end, and 24 inch centers. FIG. 2

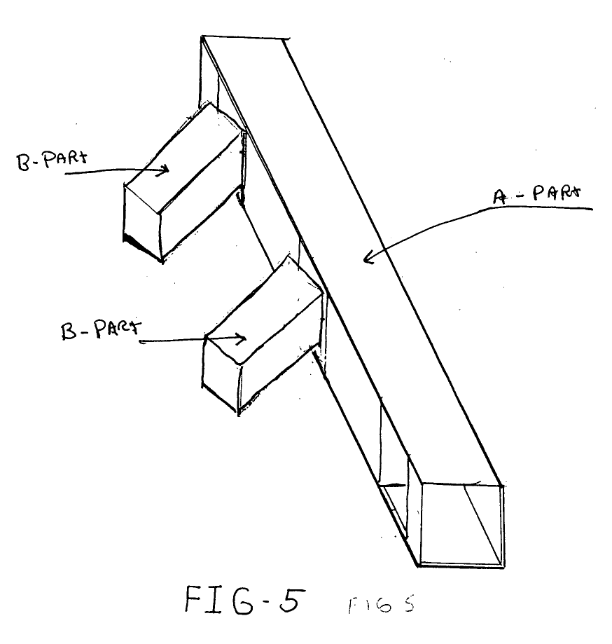

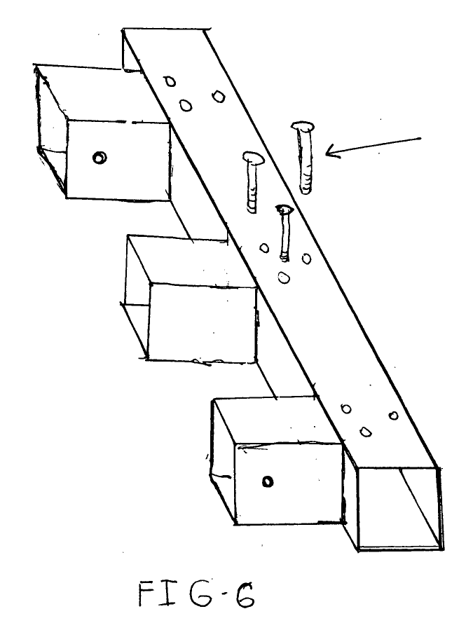

There may be inserts plae in each end of the (A) side, on each side of the end cutout. The first is the (E) part this is 4 inches in length made from 1¾ inch square by ¼ inch thick, Fiber Reinforced Polymer Composites and/or metal. These will be to give the wheel mounts extra support. The (E) part may be secured by screw, glue or rivet. FIG. 3

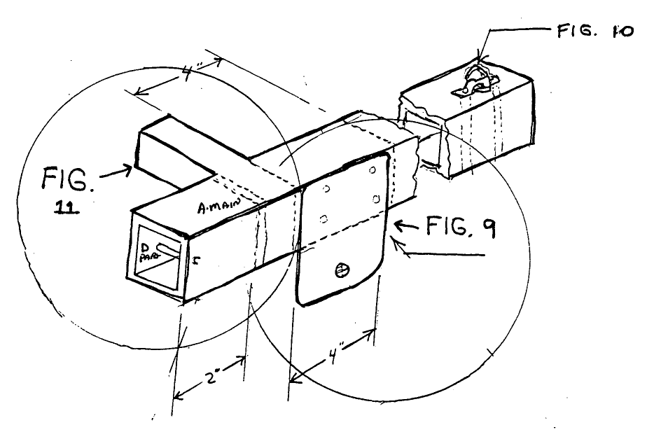

There may be inserts placed in each end of the (A) main side. The (D) parts are 2 inches in length made from 1¾ inch square by ¼ inch thick, Fiber Reinforced Polymer Composites and/or metal. These will give the Foot and Head anchor straps extra support. The (D) part may be secured by screw, glue or rivet. FIG. 4

The main cutouts in FIG. 2 (Page 2) in the (A) main will accept the protrusion that is the (B) Cross Member Support. This is 6 inches in length made from 1¾ inch square by ¼ inch thick, Fiber Reinforced Polymer Composites and/or metal. FIG. 5

There maybe 2-3 of these on each side, facing inward to except cross member (C). The protrusion (B) Cross Member Support is permanently secured by screws, rivets and/or glue, to the inside of (A) and are mounted at a 90-degree angle.

There may be up to 4 holes drilled in the (A) and (B) parts at the looation shown these may be 3/16″ to ¼″. The bolts may be either carriage or hex head same size as the holes and either 2¼″ to 2½″ inches long. The Head and Foot B Parts will have holes to accept locking pins one size larger than the one in the (C) parts. FIG. 6. There are to be Two of each of the (A) Assembly one right and one left.

Photo #6 this is the close up showing FIG. 4 inserted and FIG. 6 The (A) Side end may have a bolt going thru it this holds the (D) part in place and is the anchor point for the head or foot straps.

Photo #4 this shows the A main side and B Cross Member Supports in place. Photo of the (A) Main Sides, 2—two of them a Left and Right with (B) protrusions mounted. Photo 15

The wheel mounts are to be mounted about 4 inches from each end on the outside of the main (A) side. There are 4 of them. FIG. 9

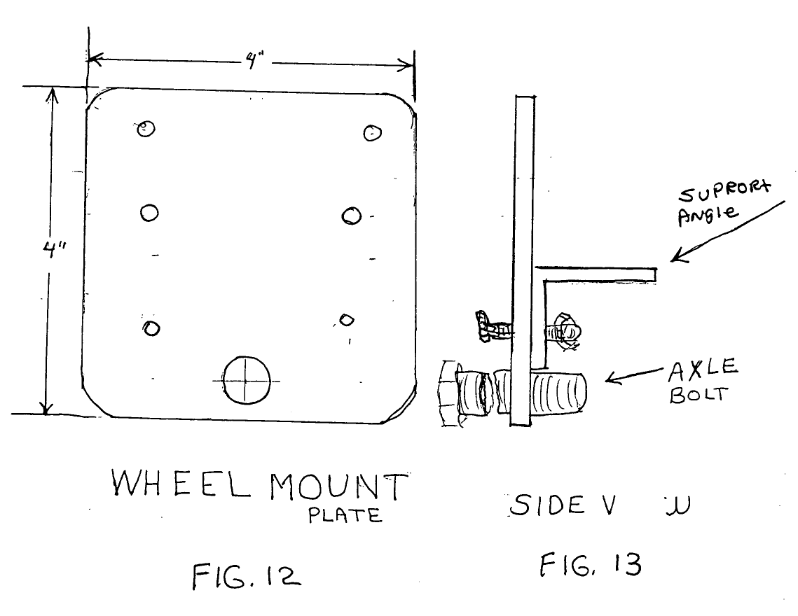

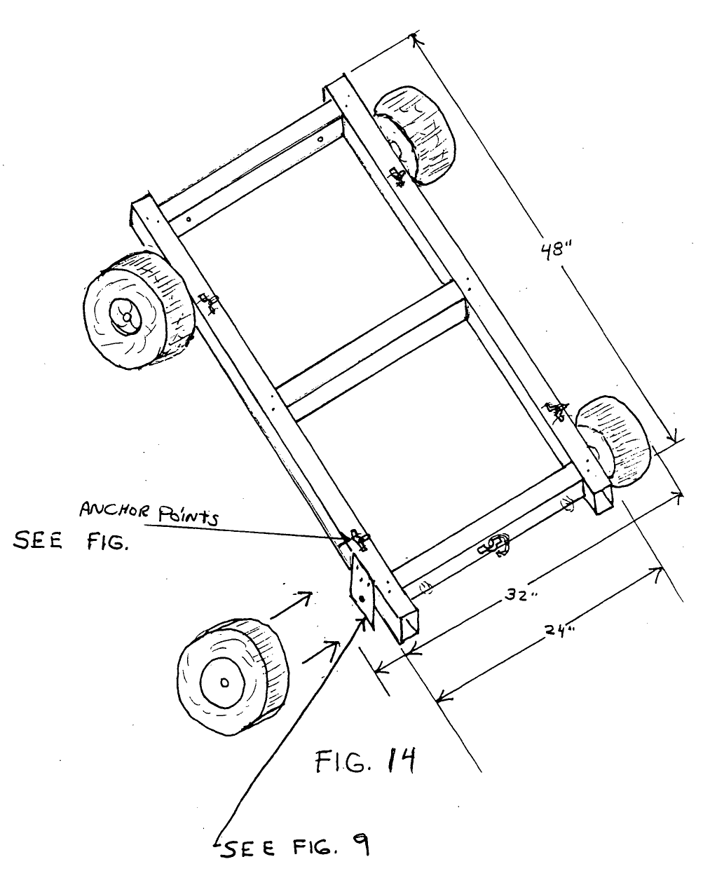

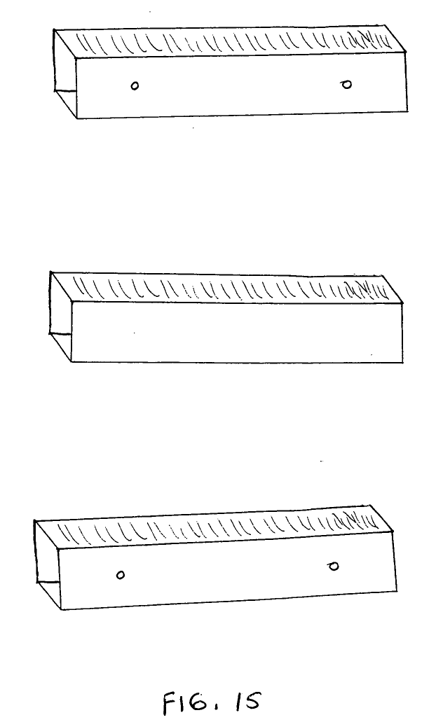

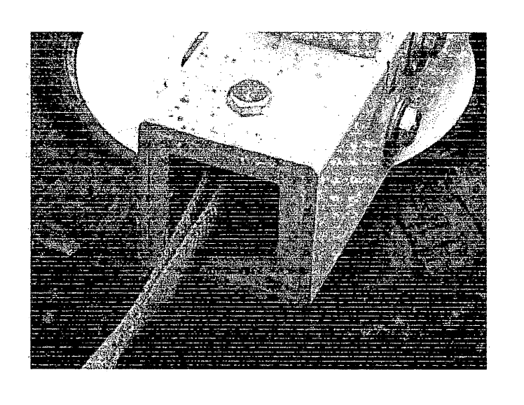

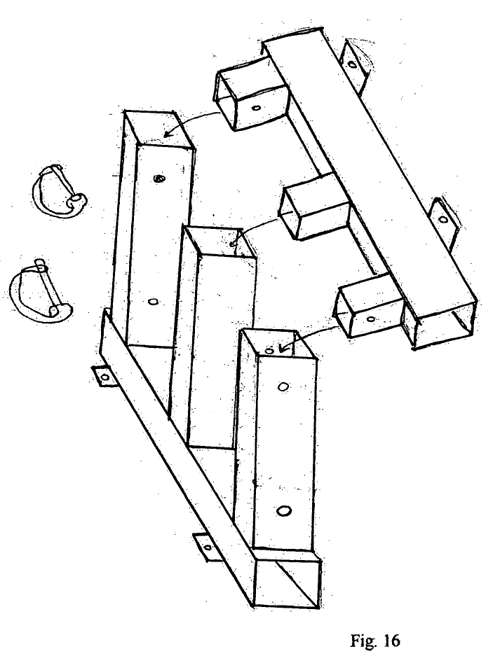

The wheel mount may have a metal angle to help support the wheel mount. FIG. 13. There may also be a mounting plate this bind about 1¾ inches by 4 inches.

The wheel mount may be made from metal or other material of a thickness to support the load. The plate may have rounded comers and be about 4 inches square. The plate may be drilled with ½ inch or ⅝ inch hole for the axle. the hole is to be centered and about 1½ inches from the bottom. The plate may also have (2-4) holes 3/16 inch or ¼ inch to be used to mount the plate to the (A) Side. These are to be drilled ¾ inch from the top and ¾ inch from the side. There are also (2) holes drilled 1½ inch from the bottom for the angle. FIG. 12 Page 12

The wheel mounts are to be mounted about 4 inches from each end on the outside of the main (A) side. Photo 7

The (B) Cross Member Support is to support the (C) cross member. The (C) cross member may be 20 to 26 inches in length made from 2-inch square by ⅛ inch thick, Fiber Reinforced Polymer Composites. FIG. 15. The Head and Foot C Parts will have holes to accept locking pins. The Head (C) Cross member may have an anchor mount to connect safeties from the main lines. See Detail Page 2 Photo #9

The C Cross Member may have a non-slip surface. The head Cross member may have an anchor point. Photo #7

The wheel mounts are to be mounted about 4 inches from each end on the outside of the main (A) side. FIG. 14. With the above Assembly of the (A) main sides and the (C) Cross Members.

This is all of assembly of the RB Transporter the following are the steps in the set-up of operation.

There are only 5 main components to the unit, no screws, bolts or hardware needed. The wheel mounts are to be mounted about 4 inches from each end on the outside of the main (A) side. FIG. 14

With the above Assembly of the (A) main sides and the (C) Cross Members. This is all of assembly of the RB Transporter the following are the steps in the set-up of operation. There are only 5 main components to the unit, no screws, bolts or hardware needed.

Tires and wheels are to be solid, pneumatic or flat free type tire. These may have ½″ to ⅝″ axle with off set to clear inside of wheel to mount to the mounting bracket. The tire at the foot may be smaller than the tires at the head. This may raise the head patient's head slightly. Photos 12 and 13

The last components are the mounting straps, these may be ratchet, snitch, made from webbing or rope. These may have a metal, plastic, ratchet buckle or connector. The straps are mounted at the anchor points (2) two on each side. The anchor mounts are of an outside manufacture and are bolted with (2) bolts and may be bolted on the side, bottom or top of the (A) main side about 18 inches from each end. There may also be one on the Head (C) Cross member. Photo 16 FIG. 10

The last four mounting straps may be mounted as follows: With the bolts at the ends of the (A) main Sides (2) two at the head end and (2) two at the foot end. Photo 17

Floats these are made of foam, Plastic and are 48-60 inches long, and about 4-6 inches in diameter. The floats connect to the RB Transporter by webbing straps rope or rubber straps.

The assembly of the RB Transporter, take one of the (A) main sides and lay it on it's side. Take the Head Cross Member this may have the front safety anchor on it, and has holes to except the locking pins. This then gets placed over the middle B cross member Support Photo #7

Take the Middle Cross ember this then gets placed over the middle B cross member Support. Photo #8

Take the Foot Cross this has holes to except the locking pins. This then gets placed over the Foot B cross member Support. Photo #9

With the unit stil on the floor, place the other (A) Main Side into the (C) Cross members, then these side may be secured with pins, webbing straps or shock cords. For easy of understanding wheels are not pictured. FIG. 16

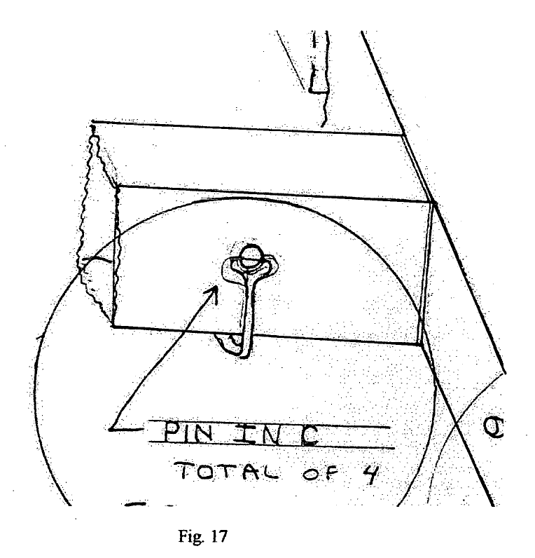

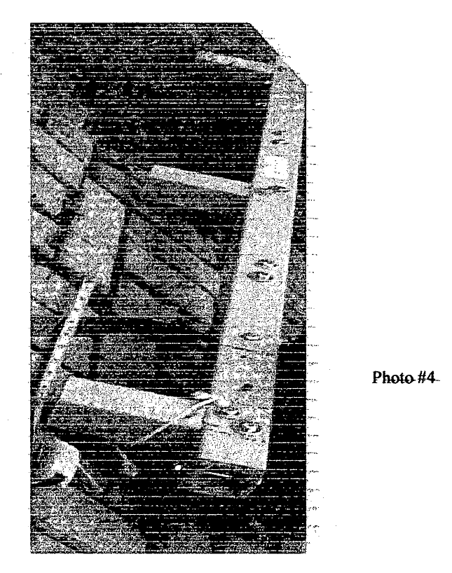

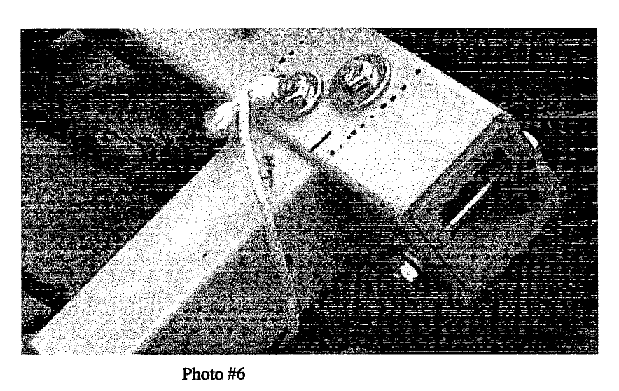

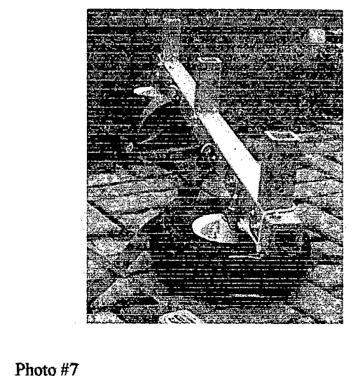

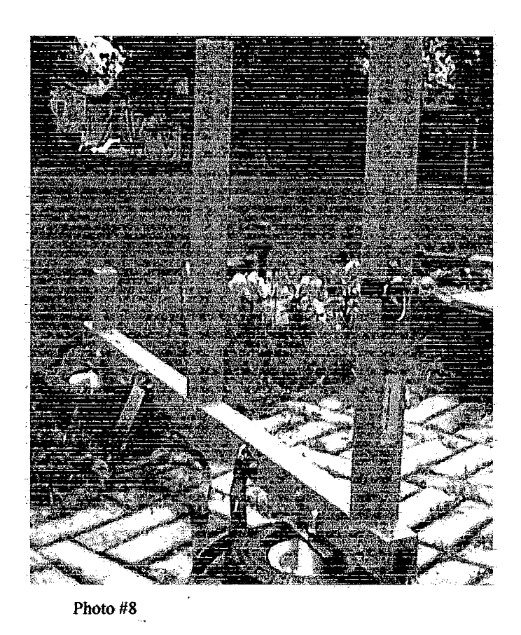

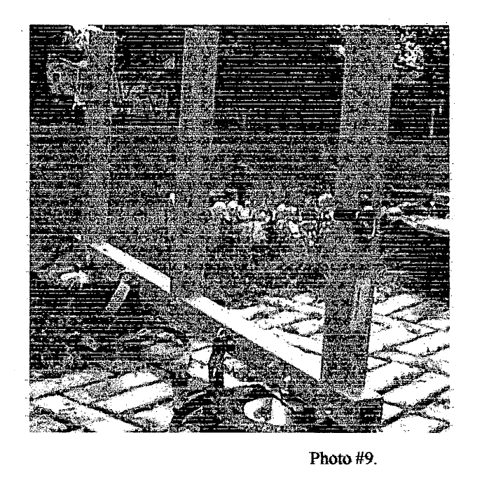

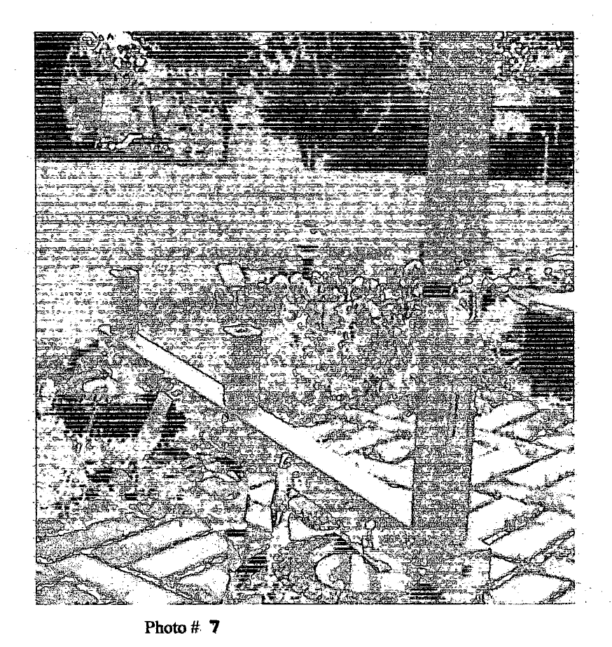

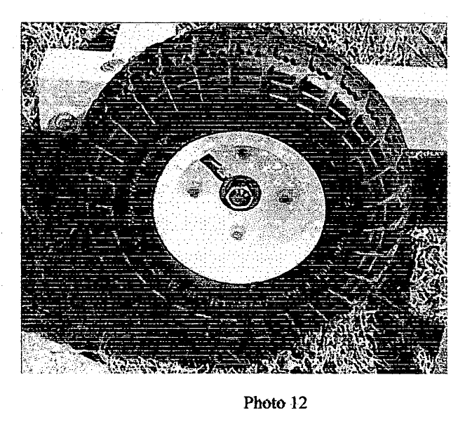

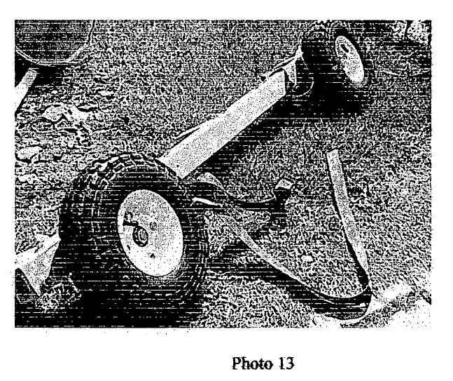

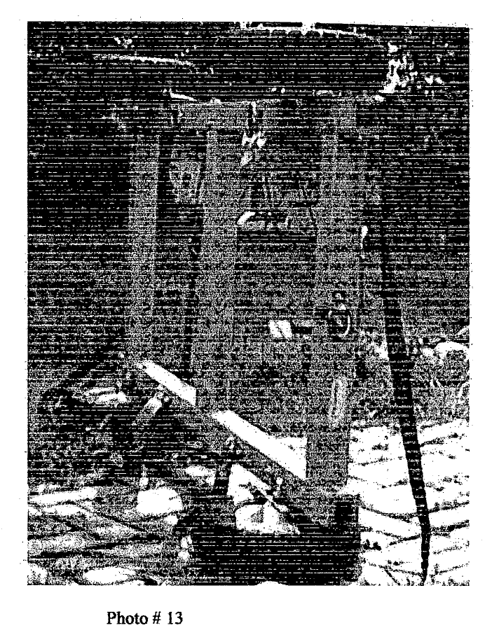

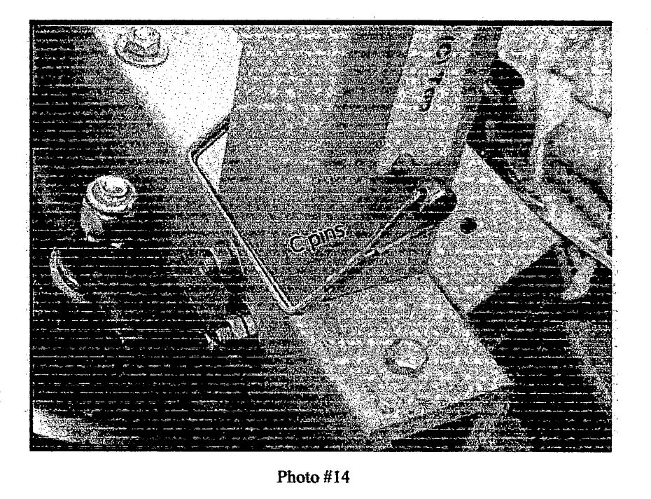

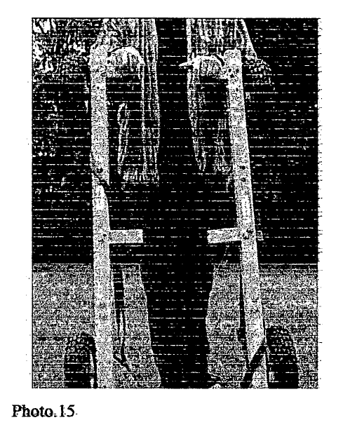

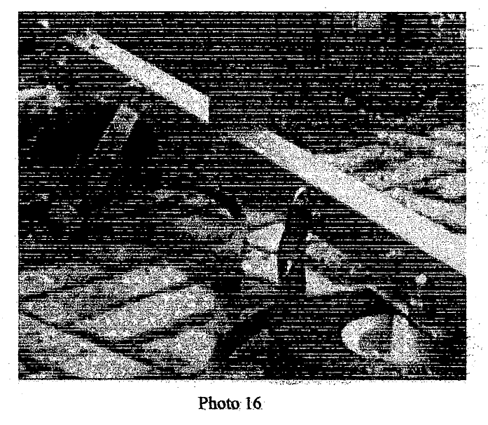

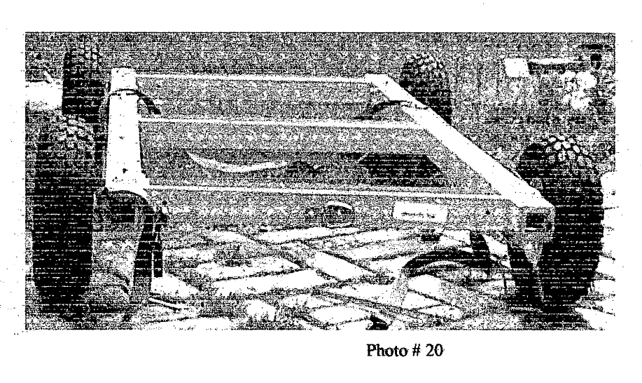

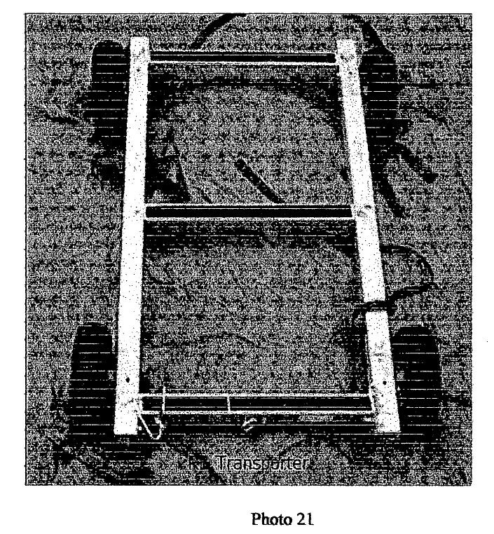

The C Pins are put in the 2 ends of the C Cross member one on each side. FIG. 17 to left.

The RB Transporter then can be placed on its wheels and is ready for use. Photo #13

Here the C Pins are used to secure the C cross members to the B cross member support. (1)Near each of the four corners. Photo 14

The RB Transporter is now ready. Photo 20 To accept the rescue basket, back board, or Shed. Photo 21

1. What I claim as my invention is the RB Transporter, this is a unit to Transport a rescue basket, backboard or Sked stretcher. It is made from metal, and fiber reinforced polymer composites, components maybe secured by screws, rivets, and or glue. The RB Transporterwas developed over the last two months of 2003, through June of 2004. With 24 years in the emergency services, I understood some problems with transporting a rescue basket. The RB Transporter my invention is as follows a lightweight easy to assemble piece of equipment, consist of one (A) right main side and a left main side. Each side will have two wheels, and two to three anchor attachment points. There'll be three cross members, these will slide over the (B) parts and connect with pins. All five of these components will take the space of a 12 by 12 by 48 in. long. The RB Transporter can be stored in the rescue basket or transporter bag. What makes the unit different? Are the four wheels this makes the RB Transporter stable and movement easy. With being in the emergency services 24 years, and selling equipment for 20 years there is no other product on the market that will do what the RB Transporter does, in helping make the rescue scene safer.
